(19) United States
(12) Patent Application Publication
(10) Pub. No.: US 2022/0289462 A1
(43) Pub. Date: Sep. 15, 2022

(54) PORTABLE RIGID COOLER AND BEVERAGE DISPENSER WITH LEGS THAT EXTEND AND RETRACT

(71) Applicant: DuckUp LLC, Hoboken, NJ (US)

(72) Inventor: Steven Papera, Hoboken, NJ (US)

(21) Appl. No.: 17/694,215

(22) Filed: Mar. 14, 2022

Related U.S. Application Data
(60) Provisional application No. 63/160,261, filed on Mar. 12, 2021.

(51) Int. Cl. B65D 81/38; F25D 23/12; B62B 1/20; F25D 3/08; B65D 43/16

(52) U.S. Cl. CPC B65D 81/3813; F25D 23/126; B62B 1/208; F25D 3/08; B65D 43/16

(57) ABSTRACT

In one aspect of the subject invention, a cooler is provided herein including a body having an insulated bottom and insulated upstanding side walk enclosing an interior volume, the side walls terminating at a free edge Which defines an opening to the interior volume. A first opening is formed through a first of the side walls. At least one lid is also provided for selectively covering the opening. A well is also provided including a reservoir, configured to accommodate a beverage, and a spigot, configured to selectively pour out the beverage. The well is configured to be removably emplaced in the interior volume of the body, being wholly contained therein, and with the spigot passing through the first opening to extend beyond the first side wall. Advantageously, the subject invention provides for an enclosed reservoir of beverage, which may be maintained in a cool state and conveniently dispensed.

### CROSS-REFERENCE TO RELATED APPLICATION

This application claims priority to U.S. Provisional Application No. 63/160,261, filed Mar. 12, 2021 the entire contents of which are incorporated by reference herein.

### FIELD OF THE INVENTION

The invention relates generally to portable rigid cooler and beverage dispenser with legs that extend and retract.

### BACKGROUND OF THE INVENTION

Currently, there are a number of solutions for a portable rigid cooler or a portable table. Some of these solutions attempt to offer an option for a portable rigid cooler that can be made accessible to users without requiring them to bend over to access the cooler, but these solutions fail to meet the needs of the industry because they do not contain a fully integrated solution that allows the cooler to stand independently nor do they include optional beverage dispensing functionality. Other solutions attempt to offer an independent standing cooler by offering a permanent stand or cooler with fixed legs, but these solutions are similarly unable to meet the needs of the industry because they are not easily portable and do not offer the full versatility of a portable rigid cooler and also do not include a removable drink well for beverage dispensing functionality. Still, other solutions seek to use a fabric-shell cooler that stands and collapses the entire cooler, but these solutions also fail to meet industry needs because they are not as durable or well-insulated, are not portable when filled with contents, and also do not include beverage dispensing functionality.

### SUMMARY OF THE INVENTION

In one aspect of the subject invention, a cooler is provided herein including a body having an insulated bottom and insulated upstanding side walls bounding the bottom, the bottom and side walls enclosing an interior volume, the side walls terminating at a free edge which defines an opening to the interior volume. A first opening is formed through a first of the side walls. At least one lid is also provided for selectively covering the opening. A well is also provided including a reservoir and a protruding spigot. The reservoir is configured to accommodate a beverage, with the spigot configured to selectively pour out the beverage. The well is configured to be removably emplaced in the interior volume of the body with the reservoir being wholly contained within the interior volume of the body and with the spigot passing through the first opening to extend beyond the first side wall. Advantageously, the subject invention provides for an enclosed reservoir of beverage, which may be maintained in a cool state and conveniently dispensed.

In a further aspect of the subject invention, a cooler is provided including a body having an insulated bottom and insulated upstanding first, second, third, and fourth side walls bounding the bottom, the bottom and upstanding side walls enclosing an interior volume, the side walls terminating at a free edge which defines an opening to the interior volume. The third side wall and the fourth side wall are spaced apart and extend between the first side wall and the second side wall, with the first side wall and the second side wall each generally having a first length, and the third side wall and the fourth side wall each generally having a second length, the second length being greater than the first length. At least one lid for selectively covering the opening. A first set of legs is pivotally mounted to the body to be rotatable about a first axis of rotation extending along, and adjacent to, the intersection of the second side wall and the bottom. A second set of legs is pivotally mounted to the body to be rotatable about a second axis of rotation extending along, and adjacent to, the intersection of the first side wall and the bottom. The first set of legs is pivotable between a standing position, being transverse to the bottom, and a stowed position, being generally parallel to the bottom. The second set of legs is pivotable between a standing position, being transverse to the bottom, and a stowed position, being generally parallel to the bottom. Advantageously, the subject invention provides for a cooler having a body supportable in an elevated position, with the legs of the cooler being foldable for easier transport and storage.

It would be desirable to have a durable and well-insulated rigid cooler that does not require the user to bend over or take-up valuable table space to access the contents. Furthermore, it would be desirable to have a convenient beverage dispenser that allows the contents to be chilled without the need to insert ice into the drink well, thereby avoiding watering-down any beverage best served with certain ratios of contents. Still, further, it would also be desirable to have various accessories within arms' reach without the need to sacrifice table space, which tends to be at a premium. The disclosed device advantageously fills these needs and addresses the aforementioned deficiencies by providing extendable legs that allow the cooler to stand at a convenient height for accessibility and that collapse with wheels for rolling to offer all the portability of the most portable of other similarly shaped rigid coolers. Furthermore, the disclosed device also includes a removable drink well that takes advantage of the standing functionality to act as an easily accessible beverage dispenser when housed on one end of the interior of cooler and chilled with the ambient chill of the ice inside the rest of the interior of the cooler. The standing functionality also accommodates various attachments for convenient access to key accompaniments to the outdoor cooler-sue experience, such as cup holders, paper towel holders, bottle openers and shelves.

Disclosed is a mobile standing cooler with beverage dispenser, which may be made up of the following components: (1) a frame having a right side, left side, bottom, and removable top, with the right and left sides being substantially parallel to each other and the top and bottom likewise being substantially parallel to each other; (2) at least two, but suitably four, legs that are in sets of two, and which pivot from each opposite end of the bottom of the cooler to sit parallel into the recessed bottom of the cooler when collapsed and extend away to offer a solid standing base; (3) at least one set of legs includes wheels at the end for easy transport when in the open and closed position; (4) a removable drink well that fits inside the cooler and is attached from the outside via a mounting ring that screws onto screw threads on the outside of the spigot of the beverage dispenser when the spigot is extended through an uncapped side drain hole.

The device may also have one or more of the following: (1) a mechanism allowing mechanical or springing retraction and extension of the legs mounted to each end of the cooler; (2) a locking mechanism attached to or combined with the legs so as to keep the legs in the open and closed positions; (3) telescoping legs to allow the legs to collapse into the walls of the cooler and extend out from said walls when released; (4) at least one lid, preferably, a two-door lid, with a door connected via a hinge attached to each end of the cooler, folding down to meet at the center when closed and opening outwards away from the ends of the cooler; (5) a beverage dispenser that has a spring-loaded sealing rubber gasket that connects to a built-in port insider the cooler with a line that runs to a built-in spigot and, when connected, pushes against the spring and lifts the gasket, to allow the contents of the beverage dispenser to flow into the line that runs to the spigot and (6) various attached or attachable accessories, including a shelf, a cup holder, a paper towel roll holder, recessed cup holders molded into the top of the lid, a bottle opener, and a bottle opener (bottle cap) catch.

The disclosed device is unique when compared with other known devices and solutions because it provides a rigid, durable and well insulated portable cooler with (1) an integrated set of legs that extend to allow the cooler to stand to convenient access height and that retract into the cooler for the cooler to be wheeled and easily transported; (2) a removable drink well that becomes a beverage dispenser when inserted to the cooler from the inside and attached from the outside; and (3) various accessories that can hang from the cooler due to the advantage of the heightened vertical position of the cooler when in the standing position, when combined with the aforementioned features, transform the cooler into the ultimate centerpiece of any outdoor gathering.

The disclosed device is unique in that it is structurally different from other known devices or solutions. More specifically, the device is unique due to the presence of (1) integrated legs that are built into the cooler and easily extended through a one or two step process by pushing the legs out of the close-point catches and past the open-point catches; and which easily retract by the user grabbing the cooler and pushing the legs out of the open-point catches and then pushing past the closes-point catches; (2) a removable drink well that transforms one end of the cooler into a beverage dispenser, the contents of which are cooled by the ambient chill of the ice in the rest of the cooler and easily attached through an uncapped drain hole and twisting on an external locking ring, with said drink well easily cleanable and dish washable when removed; and (3) the optionality of various accessories that are easily hung from the cooler for convenient access, particularly while in the standing position, including a bottle opener and catch, folding shelf, cup holder and paper towel roll holder.

This disclosure will now provide a more detailed and specific description that will refer to the accompanying drawings. The drawings and specific descriptions of the drawings, as well as any specific or alternative embodiments discussed, are intended to be read in conjunction with the entirety of this disclosure. The portable rigid cooler and beverage dispenser with legs that extend and retract may, however, be embodied in many different forms and should not be construed as being limited to the embodiments set forth herein; rather, these embodiments are provided by way of illustration only and so that this disclosure will be thorough, complete and fully convey understanding to those skilled in the art.

### BRIEF DESCRIPTION OF THE DRAWINGS

FIG. 1.—is a diagram illustrating a side view of the cooler with the legs extended in accordance with an exemplary embodiment.

FIG. 2.—is a diagram illustrating a side view of the cooler with the legs collapsed in accordance with an exemplary embodiment.

FIG. 3.—is a diagram illustrating top angled view of the cooler with the legs extended in accordance with an exemplary embodiment.

FIG. 4.—is a diagram illustrating an end view of the drain cap/spigot hole end of the cooler with the legs collapsed in accordance with an exemplary embodiment.

FIG. 5.—is a diagram illustrating a view of the cooler sliced lengthwise to show the interior and demonstrate location of handles, wheels, cover and placement of drink well, handle and legs when in the collapsed position, in accordance with an exemplary embodiment.

FIG. 6.—is a diagram illustrating a top angled view of the cooler sliced to show the interior and demonstrate location of handles, wheels, cover and placement of drink well, handle and legs when in the collapsed position, in accordance with an exemplary embodiment.

FIG. 7.—is a diagram illustrating a top-down view of the top of the cooler showing location of handles and the fully closed cover, in accordance with an exemplary embodiment.

FIG. 8-10.—show passage of a spigot of the drink well through a drain hole in the wall of the cooler, with possible use with a locking ring, split rubber film, and/or solid cap, in accordance with exemplary embodiments.

FIGS. 11-12.—show two-piece spigot arrangements useable with the subject invention.

FIGS. 13-16.—show retractable/extendable leg arrangements useable with the subject invention.

### DETAILED DESCRIPTION OF THE INVENTION

The present invention is directed to portable rigid cooler and beverage dispenser with legs that extend and retract.

Referring to the figures, a cooler 10 is provided having a body 12 with an insulated bottom 14 and insulated upstanding side walls 16 bounding the bottom 14. The bottom 14 and the side walls 16 enclose an interior volume 18. The side walls 16 terminate at a free edge 20 which defines an opening 22 to the interior volume 18. At least one lid 24 may be provided for selectively covering the opening 22 in sealing the interior volume 18. The lid 24 may be hingedly connected to the body 12, particularly exteriorly to one or more of the side walls 16, e.g., adjacent to the free edge 20. The body 12 and/or the lid 24 may be provided with various features, such as, cup holder(s), a paper towel roll holder, recessed cup holder(s) molded into the top of the lid 24, a bottle opener, a bottle opener (bottle cap) catch, and so forth. A drain hole 15 may be provided in the bottom 14.

The side walls 16 may define a rectangular shape about the bottom 14. In particular, first and second side walls 16A, 16B may each generally have a first length, with the third and fourth side walls 16C, 16D, each generally having a second length. The third and fourth side walls 16C, 16D are spaced apart and extend between the first and second side walls 16A, 16B.

A well 26 may be provided including a reservoir 28 and a protruding spigot 30. The reservoir 28 is formed to accommodate a beverage with the spigot 30 being configured to pour out the beverage from the reservoir 28. The well 26 is configured to be removably emplaced in the interior volume 18 of the body 12 with the reservoir 28 being wholly contained within the interior volume 18 of the body 12 and with the spigot 30 passing through a first opening 32 formed in the first side wall 16A. The spigot 30 is configured to pass through the first opening 32 and extend beyond the first side wall 16A.

The reservoir 28 may be formed with any shape, including being box shaped, as shown in the figures. Preferably, the reservoir 28 includes a major surface 34 which is opposite the spigot 30 and positioned to be fully exposed to the interior volume 18. This allows for the major surface 34 to be in direct contact with any cooling medium placed into the interior volume 18, such as ice, ice packs, etc., thereby allowing for more efficient conductive cooling of a beverage contained with the reservoir 28.

The reservoir 28 may be box shaped having opposing front and rear panels 36, 38, which may be each generally planar and which may be parallel. The spigot 30 may protrude from the front panel 36 and the rear panel 38 may define the major surface 34. The front panel 36 may be configured for face-to-face contact with the inner surface of the first side wall 16A. First and second side panels 40, 42, a base panel 44, and a top panel 46 may be arranged to be located between, and perimetrically bound, the front and rear panels 36, 38. The first and second side panels 40, 42 may be each generally planar and which may be parallel. Likewise, the base panel 44 and the top panel 46 may be each generally planar and which may be parallel.

Optionally, the front panel 36, the rear panel 38, the first side panel 40, and the second side panel 42 may be tapered in a direction from the top panel 46 to the base panel 44 to provide the reservoir 28 with a narrower footprint at the base panel 44 than at the top panel 46. In addition, it is preferred that the spigot 30 be located adjacent to the base panel 44. With a tapered configuration, the reservoir 28 has a funnel effect maximally collecting beverage about the spigot 30.

The reservoir 28 encloses an inner volume 48 for accommodating a beverage. A fill opening 50, which is in communication with the inner volume 48, may be formed on a top surface of the reservoir 28, e.g., in the top panel 46. Beverage may be added or removed from the inner volume 48 via the fill opening 50. A cap 52 may be provided which is removably mounted to the fill opening 48. The cap 52 may be removably mounted using any known configuration, such as a snap fit, threaded engagement, interference fit, and so forth. Preferably, the fill opening 50 is formed large enough to allow a user to reach a hand into the inner volume 48 to clean therein. The reservoir 28 is preferably formed of a thermoplastic material which allows for repeated use and washing.

The spigot 30 includes a stem 54 which is secured to the reservoir 28. The stem 54 is hollow to define an open channel 56 in communication with the inner volume 48. Beverage contained within the inner volume 48 may flow through the open channel 56. As further discussed below, valving is provided on the stem 54 to regulate flow through the open channel 56.

The bottom 14 of the body 12 may define a ledge 56, e.g., adjacent to the first side wall 16A, upon which the well 26 may be rested.

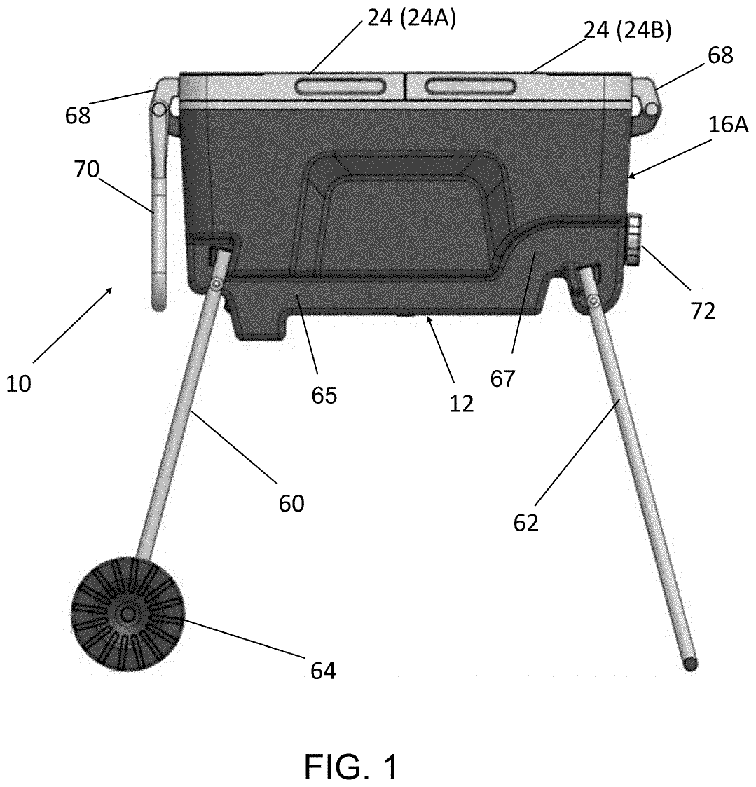

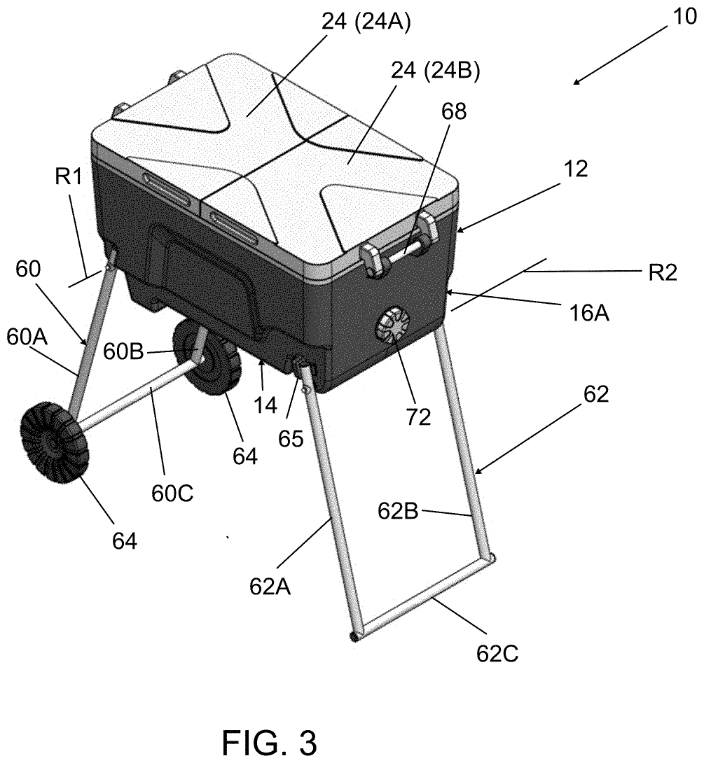

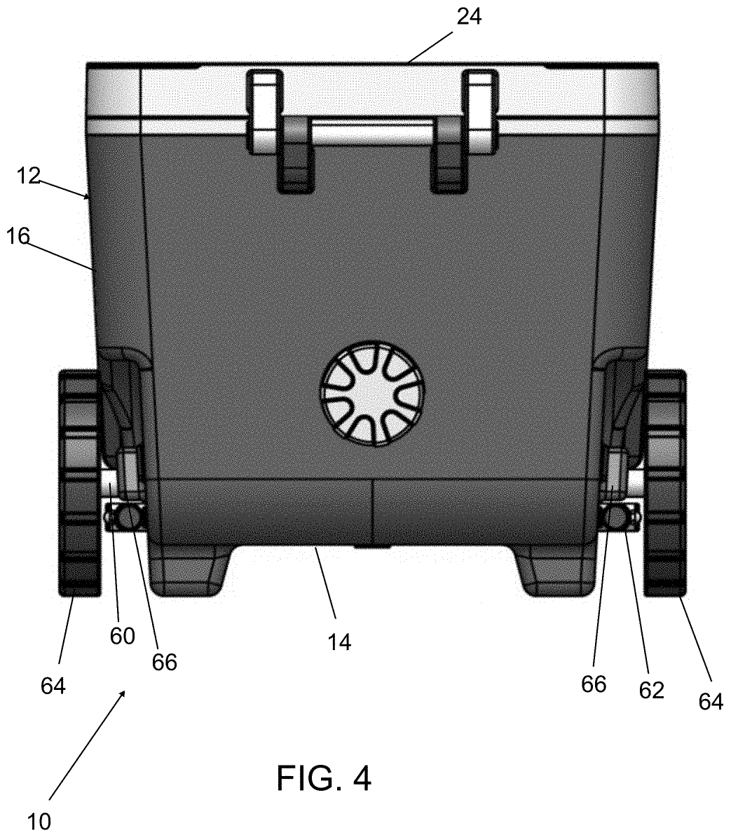

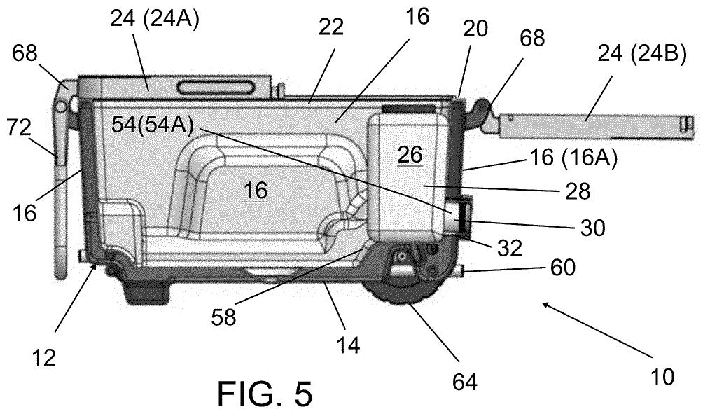

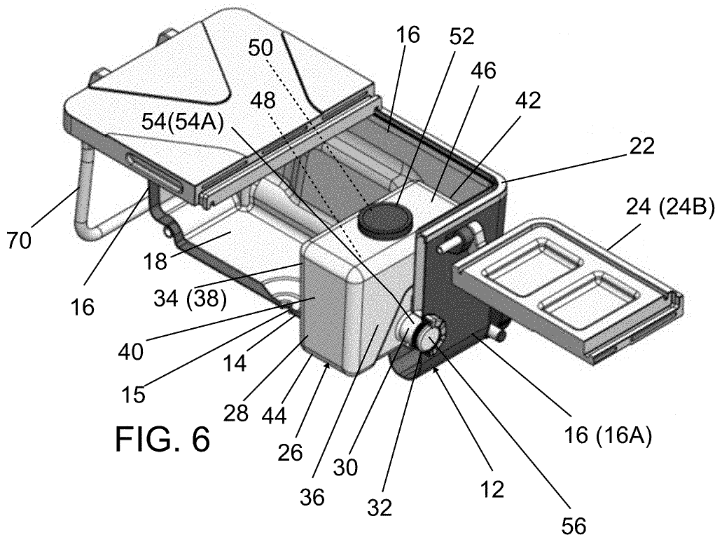

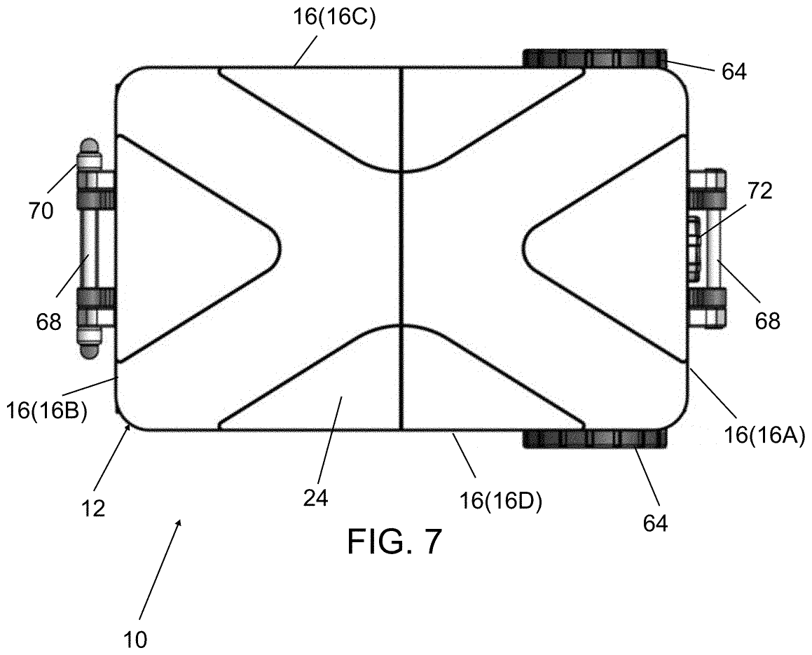

Referring now to FIG. 1, the cooler 10 is shown in a standing position, in accordance with an exemplary embodiment of the invention, with the body 12 being supported in an elevated position. As shown, the cooler 10 includes first and second sets of legs 60, 62, the first set of legs 60 having a pair of wheels 64 at the free end thereof. The first and second sets of legs 60, 62 may be held open by resilient engagement with catch-points 66 that are molded into the body 12 of the cooler 10. As shown, the cooler 10 may have handles 68 on the side walls 16, preferably on opposing sides of the body 12, which serve as grips for lifting the cooler 10. In addition, the lid 24 may be hingedly connected to one or more of the handles 68. As shown, the lid 24 may be composed of two parts 24A, 24B that fold inwardly towards the middle. The two parts 24A, 24B may be pivotally mounted to the handles 68. A secondary long handle 70 may be additionally hingedly mounted to one of the handles 68 to allow the cooler 10 to be pulled, particularly when raised on one end while resting on the wheels 64. As shown in FIG. 3, it is preferred that the first and second sets of legs 60, 62 each include two legs 60A, 60B; 62A, 62B connected by a horizontal brace 60C, 62C. The wheels 64 may be rotatably mounted to the brace 60C of the first set of legs 60.

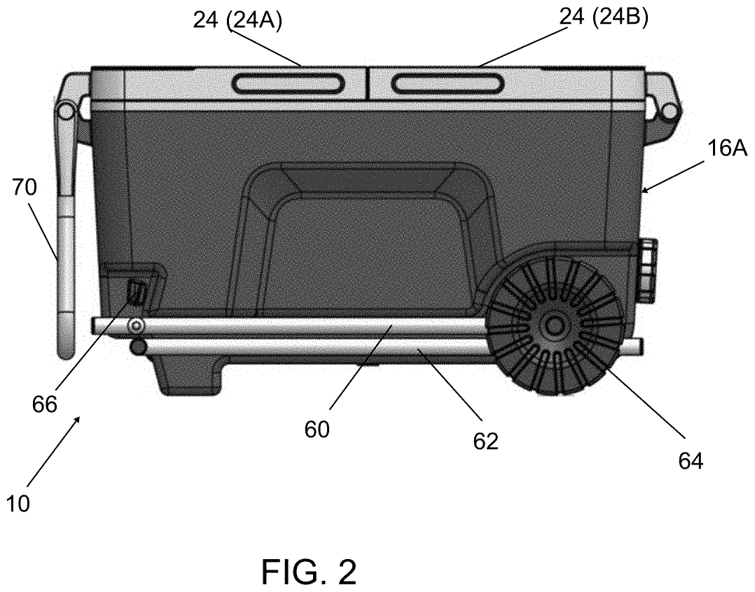

The first and second sets of legs 60, 62 may be pivotally mounted to the body 12 to be pivotable between the standing position, shown in FIG. 1, and a stowed position, shown in FIG. 2, where the first and second sets of legs 60, 62 are nested in cut-outs 65 formed in the body 12. Wheel recesses 67 may be provided as part of the cut-outs 65 to provide additional area for accommodating the wheels 64 in a stowed state, particularly, to provide clearance thereabout to allow rolling of the wheels 64. The first set of legs 60 may be pivotally mounted to the body 12 to be pivotal about a first axis of rotation R1, while the second set of legs 62 may be pivotally mounted to the body 12 to be pivotal about a second axis of rotation R2. The first axis of rotation R1 may be located to extend along, and be adjacent to, the intersection of the second side wall 16B and the bottom 14. The second axis of rotation R2 may be located to extend along, and be adjacent to, the intersection of the first side wall 16A and the bottom 14.

In the standing position, the first set of legs 60 may rest on the wheels 64. This allows for rolling transport of the cooler 10 in the standing position. In particular, with the wheels 64 being located along the same side as the second side wall 16B, the body 12 may be lifted along the first side 16A to cause the cooler 10 to pivot about the wheels 64 to allow the cooler 10 to be rolled.

It is further preferred that the secondary long handle 70 be located on the same side of the body 12 as the pivotal mounting of the first set of legs 60, e.g., being mounted on the second side wall 16B. Thus, as shown in FIG. 2, the secondary long handle 70 may be used to lift one side of the cooler 10, to pivot the cooler 10 about the wheels 64 with the first and second sets of legs 60, 62 being in the stowed position. This allows for rolling transport of the cooler 10 without the need for carrying the cooler 10.

The first and second set of legs 60, 62 are preferably configured to be splayed in the standing position, as shown in FIG. 1. As discussed above, the first and second sets of legs 60, 62 may be releasably retained in the standing position with resilient engagement with the catch-points 66. As will be appreciated by those skilled in the art, various releasable retaining arrangements may be utilized to releasably retain the first and second sets of legs 60, 62 in the standing position. In addition, catch-points 66 may be provided along the cut-outs 65 to resiliently engage the first and second sets of legs 60, 62 in the stowed position. Pivoting movement of the first and second sets of legs 60, 62 allows for engagement and release between the standing and stowed positions.

The first and second sets of legs 60, 62 may be spring loaded to be biased to the standing position. For example, torsion springs or clock springs may be mounted between the body 12 and any of the legs 60A, 60B of the first set of legs 60 and/or any of the legs 62A, 62B of the second set of legs 62 to apply rotational force about the first axis of rotation R1 and/or the second axis of rotation R2 urging the first set of legs 60 and/or the second set of legs 62 towards the standing position. The catch-points 66, in the stowed position, may resist the rotational force of the torsion springs or clock springs in maintaining the first and second sets of legs 60, 62 in the stowed position. Manual disengagement from the catch-points 66 may be utilized to release the first and second sets of legs 60, 62 with the springs urging the first and second sets of legs 60, 62 into the standing position. The catch-points 66 may be configured to be releasable, e.g., to be retractable, by movement or adjustment of one or more actuators, such as a button or knob. The actuator(s) may be located on one or more of the handles 68, 70.

The first and second set of legs 60, 62 may be also configured to be reversibly extensible, e.g., having telescoping elements, to allow for varied heights of the body 12 with the cooler 10 in the standing position.

Referring now to FIGS. 1-3, the first opening 32 is shown here capped by solid threaded cap 72 and which can be removed for draining the interior volume 18, particularly with the well 26 not emplaced therein. The solid threaded cap 72 is also removed to allow for the well 26 to be emplaced into the interior volume 18 with the spigot 30 extending through the first opening 32.

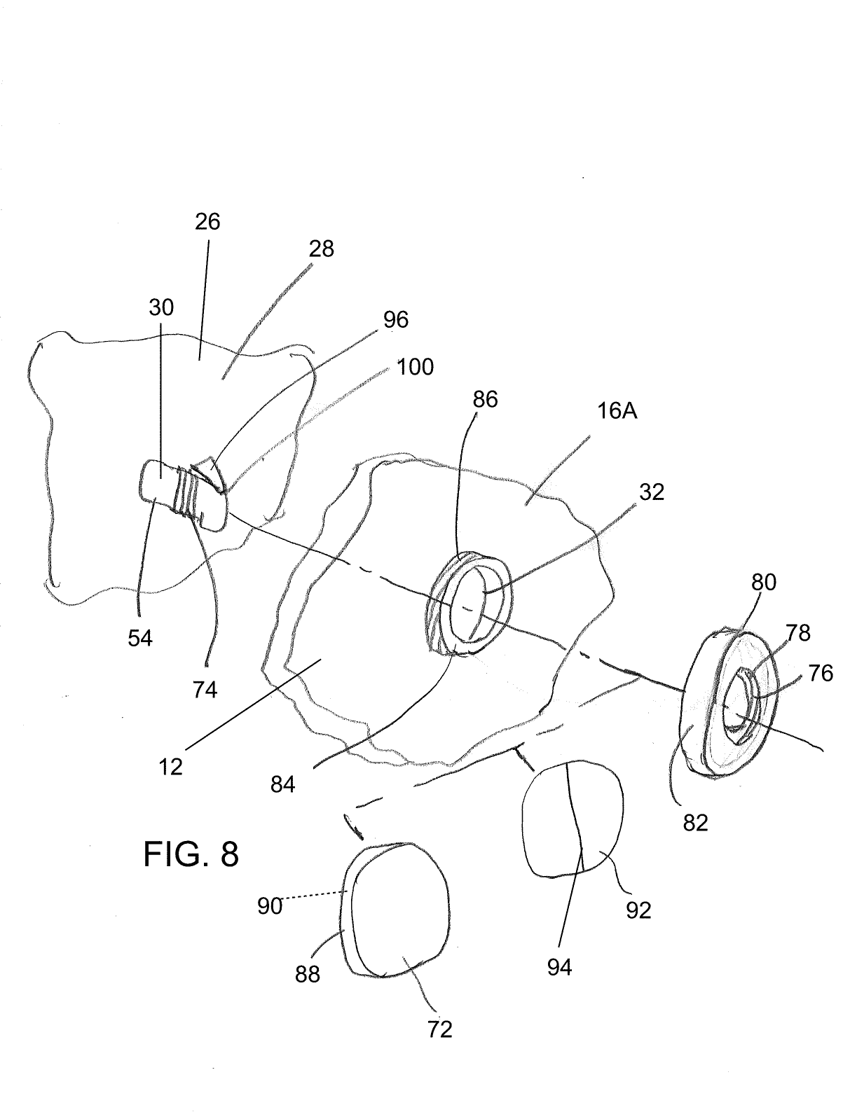

The spigot 30 may be fixed relative to the first side wall 16A to maintain the spigot 30 extending from the first side wall 16A so as to be accessible. As shown in FIG. 8, the stem 54 may be at least partially threaded with stem threads 74 along its length. The stem threads 74 are configured to be threadedly engaged by cap threads 76, formed on threaded inner wall 78 of threaded ring cap 80, with the stem 54 extending through the first opening 32. The cap threads 76 are inwardly facing on the inner wall 78. The inner wall 78 preferably has a smaller diameter than the first opening 32 so as to insertable thereinto. Tightening of the threaded ring cap 80, while in threaded engagement with the stem 54, draws the well 26 towards the first side wall 16A of the body 12 to hold the well 26 in place in order to provide external access to the spigot 30 in allowing the well 26 to serve as an externally accessible beverage dispenser. In this manner, the spigot 30 may be utilized to access liquid from the well 26, without opening the body 12, thereby better preserving any cooling medium (ice, ice packs, etc.) inside the body 12. In addition, the threaded ring cap 80 may be provided with an outer wall 82, which encircles the inner wall 18.

As shown in FIG. 8, a protruding collar 84 may be provided on the body 12, e.g., on the first side wall 16A, about the first opening 32. The exterior 86 of the protruding collar 84 may be threaded to threadedly accommodate the solid threaded cap 72. The solid threaded cap 72 may have a skirt 88 with internal threads 90 configured to threadedly engage the protruding collar 84. This allows for the solid threaded cap 72 to be mounted to the body 12 to cover the first opening 32, when the well 26 is not in use. If the threaded ring cap 80 includes the outer wall 82, it is preferably provided with an inner diameter greater than the diameter of the protruding collar 84 so as to be rotatable relative thereto without engagement therebetween. In addition, or alternatively, a split rubber film 92, or the like, may be provided across the first opening 32. The split rubber film 92 provides a covering for the first opening 32 with the well 26 not in use, and with the split 94 allowing the spigot 30 to pass therethrough when in use.

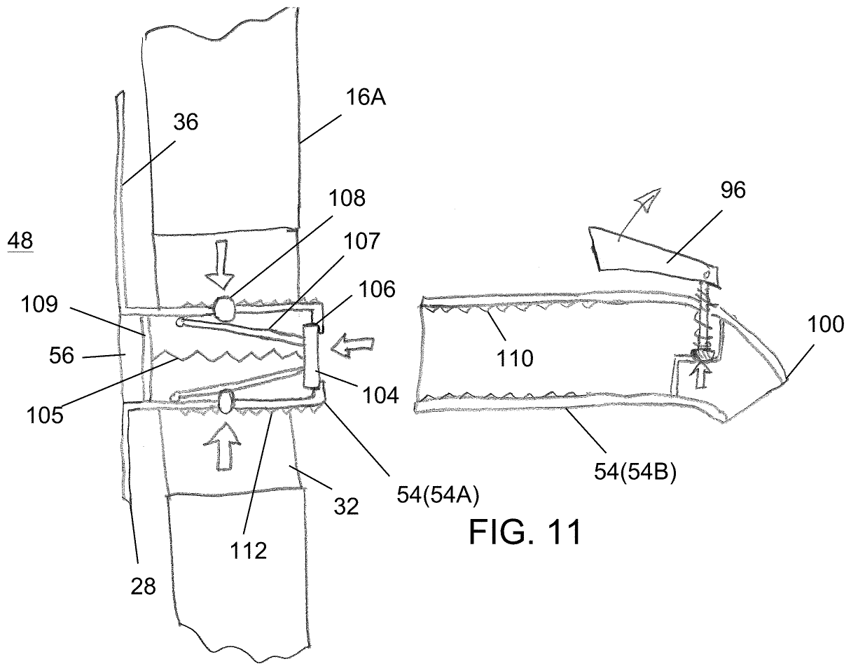

The spigot 30 may be of any known design, including using any known valving. For example, the spigot 30 may be provided with a normally-closed spring biased seal within the open channel 56 which may be displaced, to be opened, by engagement of an external handle 96 or push button 98. Release of the handle 96 or the push button 98 allows the spring biased seal to return to the closed state. In addition, the spigot 30 may be provided with a valve closure, where rotation of a rotatable handle allows for selective opening and closing of the spigot 30. A ball valve, or an equivalent, may be utilized. In addition, the spigot 30, e.g., as shown in FIGS. 8-10, may be provided as a single piece mounted to the well 26 such the spigot 30 is withdrawn through the first opening 32 with the removal of the well 26 from the interior volume 18. With this configuration, the spigot 30 may be cleaned along with the reservoir 28. Optionally, the spigot 30 may be provided in two components with the stem 54 being split between a base portion 54A, secured to the reservoir 28, and a removable portion 54B. As shown in FIG. 11, the base portion 54A may have the open channel 56 sealed with an end seal 104 which is spring-biased by spring 105 to be normally closed against valve seat 106. A circumferential protruding ring 108, formed of resilient material (e.g., elastomeric material), may be located on the base portion 54A, about the end seal 104, which is deflected radially inwardly with mounting of the removable portion 54B onto the base portion 54A. The inward deflection of the ring 108 causes rearward displacement of guide 107 which is fixed to the end seal 104, resulting in the end seal 104 separating from the valve seat 106 to permit flow therepast. The spring 105 may be supported by spring support 109, which has openings to allow flow therepast. The guide 107 may be at least partially conical and is formed with openings to allow flow therepast.

The removable portion 54B may be mounted to the base portion using any form of connection, including cooperating threads 110, 112. The removable portion 54B has an inner diameter sized to telescope over the base portion 54A in being mounted thereto.

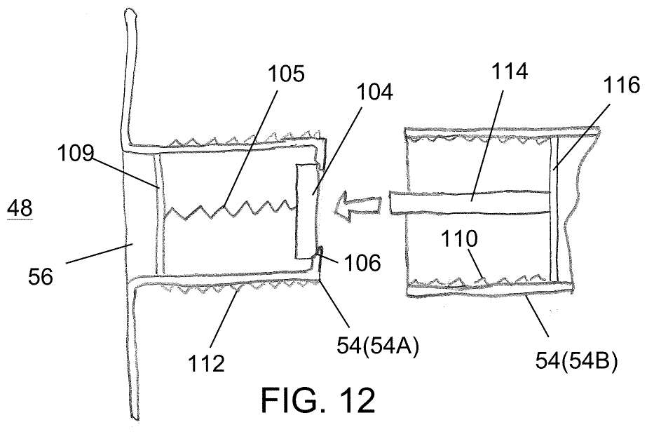

In an alternate configuration, as shown in FIG. 12, the end seal 104 may be displaced by rod 114 provided on the removable portion 54B. The rod 114 is configured to press against the end seal 104 with the removable portion 54B mounted to the base portion 54A. With full mounting of the removable portion 54B, the rod 114 causes the end seal 104 to separate from the valve seat 106 to allow flow therepast. The rod 114 may be supported by rod support 116 having openings to allow flow therepast.

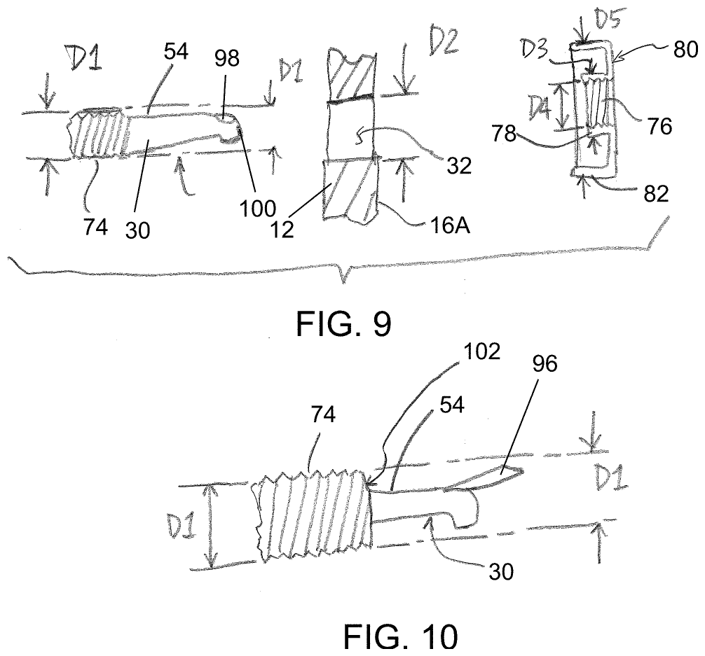

It is preferred that the inner wall 78 of the threaded ring cap 80 be capable of passing over the stem 54 of the spigot 30 so that that the threads of the inner wall 78 may threadedly engage the stem threads 74 of the stem 54. To allow for the spigot 30 to extend from the first opening 32, the stem threads 74 are spaced away from free end 100 of the spigot 30. A possible configuration is shown in FIG. 9, where the stem threads 74 define a diameter D1. The diameter D1 defines a cross-section which is larger than any portion of the spigot 30 between the stem threads 74 of the stem 54 to the free end 100 of the spigot 30. In this manner, all portions of the free end 100 of the spigot 30, including any handle 96 or push button 98, is wholly within the diameter D1. Further, it is preferred that the diameter D1 be smaller than inner diameter D2 of the first opening 32. This allows for the free end 100 of the spigot 30 and the stem threads 74 of the stem 54 to extend therethrough. It is further preferred that the inner wall 78 of the threaded ring cap 80 defines an outer diameter D3, which is smaller than the diameter D2 of the first opening 32, and an inner diameter D4, generally equal to diameter D1 of the stem threads 74 of the stem 54 to allow the cap threads 76 of the inner wall 78 to threadedly engage the stem threads 74 of the stem 54. With this configuration, the inner wall 78 of the threaded ring 80 is capable of engaging the threaded portion of the stem 54 without interference with portions of the spigot 30 or the body 12, including the first side wall 16A. It is preferred that the outer diameter D5 of the outer wall 82 of the threaded ring cap 80 be greater than the diameter D2 of the first opening 32. Optionally, the inner wall 78 of the threaded ring cap 80 may be provided with a greater length than the outer wall 82 of the threaded ring cap 80, so that, with the outer wall 82 in face-to-face engagement with the body 12, e.g., the first side wall 16A, the inner wall 78 may extend into the first opening 32.

As shown in FIG. 9, the diameter D1 may be the same or slightly larger than adjacent portions of the stem 54. As shown in FIG. 10, the stem threads 74 of the stem 54 may be enlarged relative to the stem 54 so that a shoulder 102 is defined between an adjacent portion of the stem 54 and the stem threads 74. This arrangement allows for a larger D1, which permits the handle 96 or push button 98 to define a larger footprint (but still within the diameter D1). The same geometric relationships as discussed related to FIG. 10 still apply.

Advantageously, the well 26 is removable from the body 12 for cleaning, storage, and filling. The fill opening 50 may be located at a gravitational high point, to allow for accessing of the inner volume 48 of the reservoir 28 both for cleaning and filling. The spigot 30 is preferably located at, or near, a gravitational low point in the well 26 (e.g., in proximity to the base panel 44) to allow for maximum voiding of the well 26.

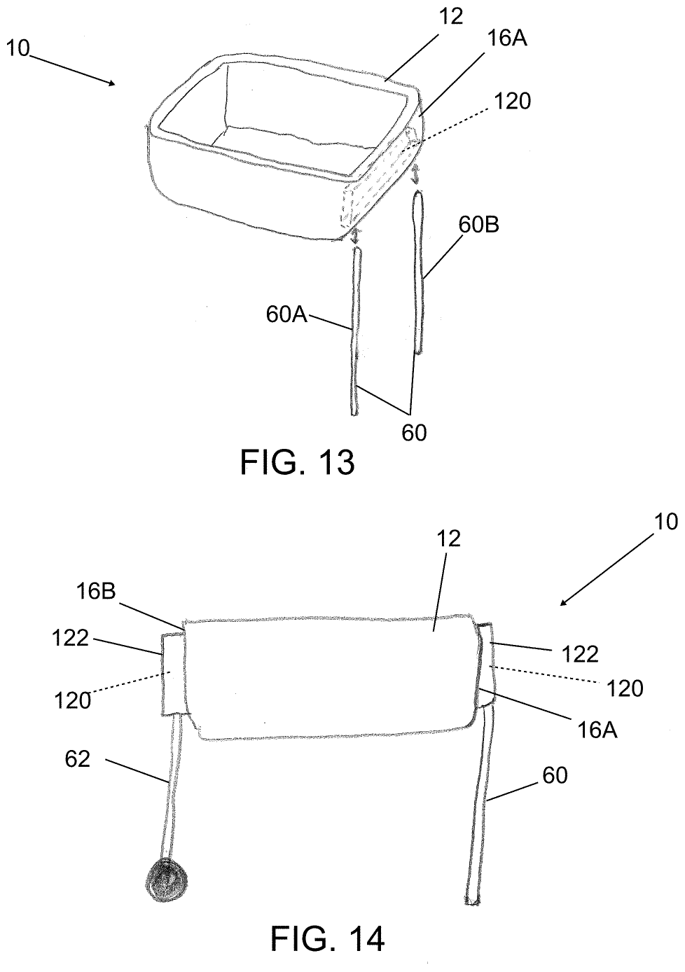

As discussed above, the first and second sets of legs 60, 62 may be pivotally mounted to the body 12 to be adjusted between the standing and stowed positions. As shown in FIGS. 13-16, in an alternate embodiment, the first and second sets of legs 60, 62 may be configured to be retracted/extended from storage channels 120 defined on the body 12. As shown in FIG. 13, the storage channels 120 may be formed in portions of the body 12, e.g., being molded into the side walls 16 (such as the first and second side walls 16A, 16B). Alternatively, as shown in FIG. 14, outer plates 122 may be mounted to the side walls 16 (e.g., the first and second side walls 16A, 16B) so that the storage channels 120 are defined between the body 12 and the outer plates 122.

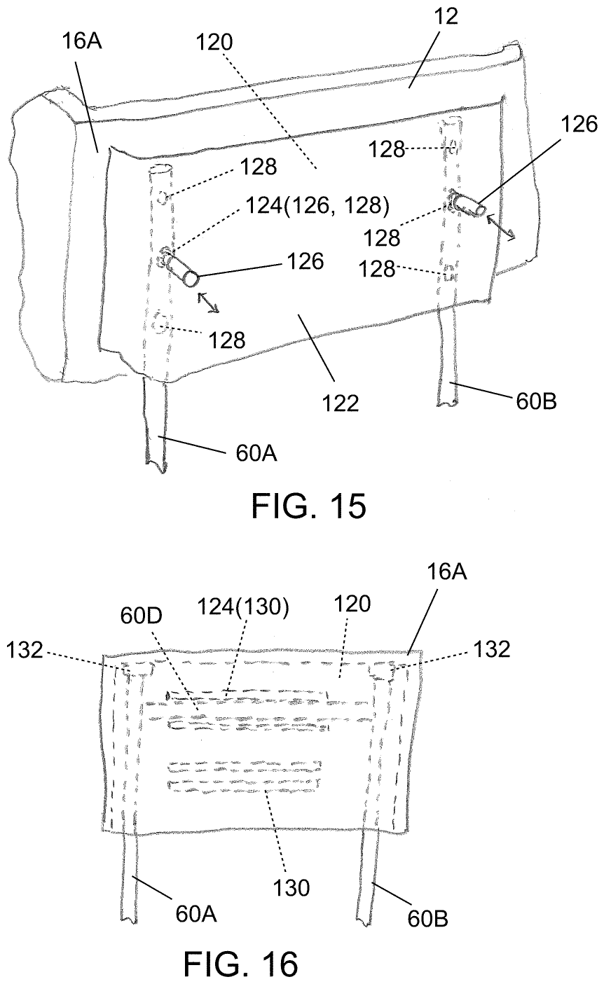

Releasable retaining elements 124 may be provided along the storage channels 120 to releasably retain the first and second sets of legs 60, 62 at varying vertical positions to provide different standing heights for the body 12. In one variation, as shown in FIG. 15, the releasable retaining elements 124 may include at least one combination of a spring biased pin 126 seatable in one or more corresponding opening(s) 128. A series of the openings 128 may be provided along any of the legs 60A, 60B, 62A, 62B positioned to correspond to different vertical positions. The spring biased pin 126 may be located on the body 12 and/or the outer plate 122, with the spring biased pin 126 being accessible to a user so as to be retractable from a normally extended position. This allows for release from the openings 128 and vertical adjustment of the legs 60, 60B, 62A, 62B. With a user's disengagement of the pin 126, the pin 126 is allowed to seat in the selected opening 128 under force of its spring.

In a further alternate embodiment, as shown in FIG. 16, the first set of legs 60 may be provided with an upper handling brace 60D extending between the respective legs thereof 60A, 60B. The releasable retaining element 124 may be configured to releasably engage the upper handling brace 60D at various vertical positions, corresponding to different settable heights for the body 12. The releasable retaining element 124 may be in the form of a spring-biased channel 130 formed to snap engage the upper handling brace 60D. An actuator, such as a depressible grip, or a depressible button, on one or more of the handles 68, 70, or other location on the body 12 or the outer plates 122, may be provided to retract the spring biased channel 130 in allowing vertical adjustment of the first set of legs 60. The second set of legs 62 may have a similar arrangement with an upper handling brace snap engageable by one or more spring-biased channels.

The first and second sets of legs 60, 62 may be retracted into the storage channels 120 to be in the stowage position. Portions of the first and second sets of legs 60, 62 may be fully retracted within, or partially extended from, the storage channels 120 in the stowed position. Partial exposure allows for the wheels 64 to be exposed, in the stowed position, for rolling transport of the cooler 10. The first and second sets of legs 60, 62 may be reversibly extensible, e.g., having telescoping elements, to allow the first and second sets of legs 60, 62 to collapse or lengthen, to allow for more compact storage within the storage channels 120.

One or more drive springs 132 may be also provided configured to urge the first and second sets of legs 60, 62 out of the storage channels 120. In this manner, with release of the first and second sets of legs 60, 62 from the releasable retaining elements 124, the first and second sets of legs 60, 62 may be driven towards the standing position, under force of the drive spring(s) 132. The releasable retaining elements 124 are configured to maintain the first and second sets of legs 60, 62 in desired vertical positions against the force of the driving spring(s) 132. Retraction of the first and second sets of legs 60, 62 into the storage channels 120 shall be against the force of the drive springs 132. The weight of the cooler 10 could be utilized to facilitate retraction against the force of the drive spring(s) 132 with the drive spring(s) 132 providing a shock absorber effect in cushioning the downward movement of the body 12.

The different embodiments herein may be provided singularly or in various combinations for a cooler. The well 26 may be used alone or in combination with the first and second sets of legs 60, 62, and vice versa.

Different features, variations and multiple different embodiments have been shown and described with various details. What has been described in this application at times in terms of specific embodiments is done for illustrative purposes only and without the intent to limit or suggest that what has been conceived is only one particular embodiment or specific embodiments. It is to be understood that this disclosure is not limited to any single specific embodiments or enumerated variations. Many modifications, variations and other embodiments will come to mind of those skilled in the art, and which are intended to be and are in fact covered by this disclosure.

It is indeed intended that the scope of this disclosure should be determined by a proper legal interpretation and construction of the disclosure, including equivalents, as understood by those of skill in the art relying upon the complete disclosure present at the time of filing.

What is claimed is:

1. A cooler comprising:
a body having an insulated bottom and insulated upstanding side walls bounding the bottom, the bottom and upstanding side walls enclosing an interior volume, the side walls terminating at a free edge which defines an opening to the interior volume, wherein, a first opening is formed through a first of the side walls;
at least one lid for selectively covering the opening; and,
a well including a reservoir and a protruding spigot, the reservoir configured to accommodate a beverage, the spigot configured to selectively pour out the beverage, wherein the well is configured to be removably emplaced in the interior volume of the body with the reservoir being wholly contained within the interior volume of the body and with the spigot passing through the first opening to extend beyond the first side wall.

2. The cooler of claim 1, wherein the reservoir includes a first side configured to be in general face-to-face contact with an inner face of the first side of the body with the well emplaced in the interior volume of the body.

3. The cooler of claim 1, wherein the reservoir includes a fill opening on a top surface thereof, the fill opening facing a portion of the opening of the body.

4. The cooler of claim 3, wherein the well further includes a cap removably mounted to the fill opening.

5. The cooler of claim 1, wherein a threaded locking ring is provided to threadedly engage threads formed on a stem of the spigot so that, with the well emplaced in the interior volume of the body and with the spigot extending beyond the first side wall, the first side wall is located between the reservoir and the locking ring.

6. The cooler of claim 1, further comprising legs to support the body in an elevated position. The cooler of claim 6, wherein at least a portion of the legs is provided with wheels.

8. The cooler of claim 6, wherein the legs are pivotable.

9. The cooler of claim 1, wherein a major surface of the reservoir faces away from the spigot and is fully exposed to the interior volume.

10. A cooler comprising:
a body having an insulated bottom and insulated upstanding first, second, third, and fourth side walls bounding the bottom, the bottom and upstanding side walls enclosing an interior volume, the side walls terminating at a free edge which defines an opening to the interior volume, wherein the third side wall and the fourth side wall are spaced apart and extend between the first side wall and the second side wall, the first side wall and the second side wall each generally having a first length, the third side wall and the fourth side wall each generally having a second length, the second length being greater than the first length;
at least one lid for selectively covering the opening;
a first set of legs pivotally mounted to the body to be rotatable about a first axis of rotation extending along, and adjacent to, the intersection of the second side wall and the bottom; and,
a second set of legs pivotally mounted to the body to be rotatable about a second axis of rotation extending along, and adjacent to, the intersection of the first side wall and the bottom,
wherein, the first set of legs is pivotable between a standing position, being transverse to the bottom, and a stowed position, being generally parallel to the bottom, and,
wherein, the second set of legs is pivotable between a standing position, being transverse to the bottom, and a stowed position, being generally parallel to the bottom.

11. The cooler of claim 10, wherein, the first set of legs includes first and second legs, which are pivotally mounted to the body, and, a horizontal brace, spaced from the bottom, connecting the first and second legs.

12. The cooler of claim 11, wherein, the second set of legs includes third and fourth legs, which are pivotally mounted to the body, and, a second horizontal brace, spaced from the bottom, connecting the third and fourth legs.

13. The cooler of claim 11, wherein, first and second wheels are rotatably mounted to the horizontal brace.

14. The cooler of claim 10, wherein, first and second wheels are rotatably mounted to the first set of legs.

15. The cooler of claim 14, wherein, in the standing position, the first set of legs rests on the wheels.

16. The cooler of claim 15, wherein, with the first and second sets of legs in the stowed position, the cooler rests, at least in part, on the first and second wheels.

17. The cooler of claim 16, wherein, with the first set of legs in the stowed position, the first and second wheels are located adjacent to the first side wall.

18. The cooler of claim 17, further comprising a handle mounted to the second side wall, wherein, with the first and second sets of legs in the stowed position, the handle being useable to pivot the cooler about the first and second wheels to allow the cooler to roll.

19. The cooler of claim 10, wherein catch-points are provided on the body to releasably engage the first and second sets of legs in the standing position.

20. The cooler of claim 10, wherein the first and second sets of legs nest in cut-outs formed in the body.
